(19) United States
(12) Patent Application Publication
(10) Pub. No.: US 2021/0094470 A1
(43) Pub. Date: Apr. 1, 2021

(54) FOLDING TYPE INFLATABLE TRAFFIC ACCIDENT NOTIFICATION DEVICE

(71) Applicant: Dong Muk KIM, Seongnam-si (KR)

(72) Inventor: Dong Muk KIM, Seongnam-si (KR)

(21) Appl. No.: 17/105,646

(22) Filed: Nov. 27, 2020

Related U.S. Application Data
(63) Continuation-in-part of application No. PCT/KR2019/007362, filed on Jun. 18, 2019.

(30) Foreign Application Priority Data
Feb. 18, 2019 (KR) 10-2019-0018663

(51) Int. Cl. B60Q 7/00; F21V 23/00; F21L 4/02; G09F 13/00

(52) U.S. Cl. CPC B60Q 7/00; F21V 23/006; F21Y 2103/10; G09F 13/005; F21L 4/02

(57) ABSTRACT

Provided is a folding type inflatable traffic accident notification device including a foldable tube member which is made of a material that is inflatable according to gas injection, and has a bendable part to be foldably fabricated when being inflated according to gas injection, and includes a connection part used to fix the corresponding shape when the shape of a traffic accident notification sign is made through folding in the inflated state; and a light member provided in the foldable tube member, wherein the light member includes at least one of a light emitting apparatus and a light reflector.

### CROSS REFERENCE TO PRIOR APPLICATION

This application is a Continuation-In-Part application of International application PCT/KR2019/007362 filed on Jun. 18, 2019, which claims priority to Korean application 10-2019-0018663 filed on Feb. 18, 2019, which is hereby incorporated by reference in its entirety.

### BACKGROUND

The present invention relates to a folding type inflatable traffic accident notification device as an accident notification device used for accident notification and prevention of a secondary accident when a traffic accident occurs on the road.

As a traffic accident notification device, conventionally, a tripod was mainly used. However, in the case of the existing tripod, there is a problem that the tripod is not visible from a distance even if the tripod is installed, and the tripod becomes an obstacle on the road to cause a secondary accident of vehicles behind. In particular, when the traffic accident occurs on the road at night, even if the tripod is installed, it is difficult for the vehicles behind and the third drivers to identify the tripod, and there are many cases where the cars behind collide with the installed tripod to cause a secondary accident.

In addition, since the conventional tripod has considerable weight and volume, users have experienced various inconveniences in terms of portability and storage.

### SUMMARY OF THE INVENTION

The present invention is derived to solve the aforementioned problems and an object of the present invention is to provide a folding type inflatable traffic accident notification device as an accident notification device used for accident notification and prevention of a secondary accident when a traffic accident occurs on the road.

According to an aspect of the present invention, there is provided a folding type inflatable traffic accident notification device including: a foldable tube member which is made of a material that is inflatable according to gas injection, and has a bendable part to be foldably fabricated when being inflated according to gas injection, and includes a connection part used to fix the corresponding shape when the shape of a traffic accident notification sign is made through folding in the inflated state; and a light member provided in the foldable tube member, wherein the light member includes at least one of a light emitting apparatus and a light reflector.

According to the embodiment of the present invention, the folding type inflatable traffic accident notification device has an excellent effect in terms of portability and storage as compared to accident notification devices such as an existing tripod.

According to the embodiment of the present invention, there are advantages in that the folding type inflatable traffic accident notification device is not only folded and used by bending the shape into a triangle when using, but also inflated through gas injection according to a situation to be used while being shaken with a hand in a straight state or attached to the vehicle as it is, so that it is possible to be used even in situations viewed from a distance and to be folded flat and stored in a small size while gas is not injected.

### BRIEF DESCRIPTION OF THE DRAWINGS

FIG. 1 is a perspective view illustrating a folding type inflatable traffic accident notification device according to an embodiment of the present invention, when the traffic accident notification device is folded and fixed into a tripod shape of a traffic accident notification sign while inflated through gas injection.

FIG. 2 is a front view of FIG. 1.

FIG. 3 is a cross-sectional view illustrating a state when the traffic accident notification device is viewed from the front after being fully unfolded by releasing folding in FIG. 1.

FIG. 4 is an enlarged view of a part A of FIG. 3, and a diagram specifically illustrating a functional module inserted into a tube.

FIG. 5 is a view illustrating another embodiment of the present invention to which a structure for maintaining a shape between tube parts in an inflated state is applied based on FIG. 3.

FIGS. 6 and 7 are views illustrating an embodiment of a method of implementing a bendable part in the folding type inflatable traffic accident notification device according to the embodiment of the present invention.

### DETAILED DESCRIPTION

The present invention may have various modifications and various embodiments and specific embodiments will be illustrated in the drawings and described in detail in the detailed description. However, this does not limit the present invention within specific embodiments, and it should be understood that the present invention covers all the modifications, equivalents and replacements within the idea and technical scope of the present invention.

In describing the present invention, a detailed description of related known technologies will be omitted if it is determined that they unnecessarily make the gist of the present invention unclear. In addition, numeral figures (for example, first, second, and the like) used during describing the specification are just identification symbols for distinguishing one element from another element.

Further, in the present specification, if it is described that one component is “connected to” or “accessed” the other component, it is understood that the one component may be directly connected to or may directly access the other component but unless explicitly described to the contrary, another component may be connected or accessed between the components.

A folding type inflatable traffic accident notification device according to an embodiment of the present invention includes: a foldable tube member; and a light emitting apparatus installed on the foldable tube member. Here, the foldable tube member is basically made of a material that is inflatable according to gas injection, and has a bendable part to be foldably fabricated when being inflated according to gas injection. Accordingly, the shape of the traffic accident notification sign may be made through folding in the inflated state. At this time, in order to fix the corresponding shape in the final folded state, the foldable tube member may be provided with connection parts (see reference numerals 115c and 115d in the drawing description to be described below).

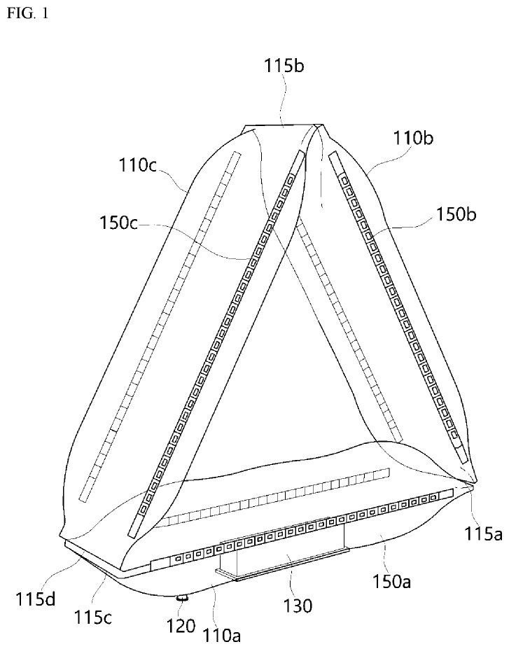

As the traffic accident notification sign, in this specification, as illustrated in FIG. 1, it will be mainly described when a tripod-shaped sign is used, but the sign does not necessarily have a tripod shape, and of course, it is possible to implement more various shapes through various folding within the limit of functioning as a traffic accident notification sign. This is because the final shape when folding may be very diverse by variously deforming the number, positions, and formation patterns of the bendable parts and by variously deforming the shape of the tube member itself.

However, hereinafter, for convenience and concentration of description, the present invention will be described based on the embodiment illustrated in FIGS. 1 to 6. In addition, for the efficiency of the use of terms in the present specification, the “folding type inflatable traffic accident notification device” illustrated in FIGS. 1 to 6 will be briefly referred to as “a tube type foldable tripod”.

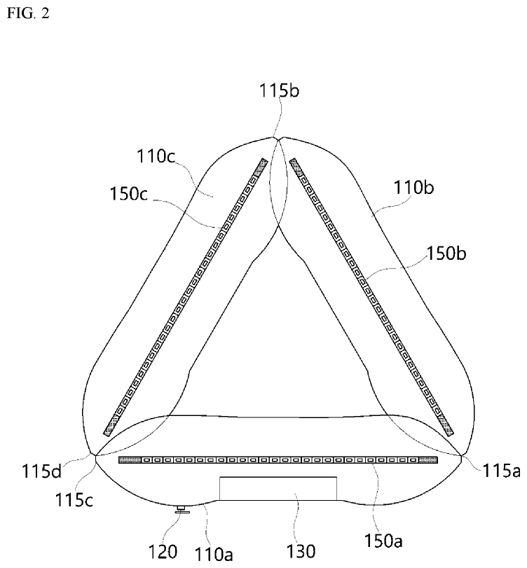

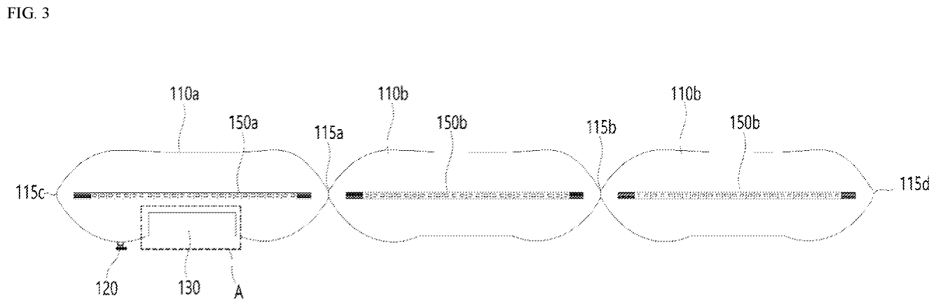

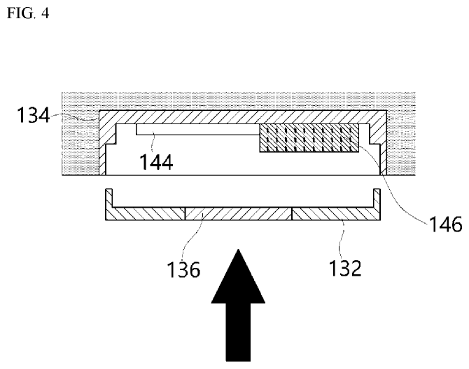

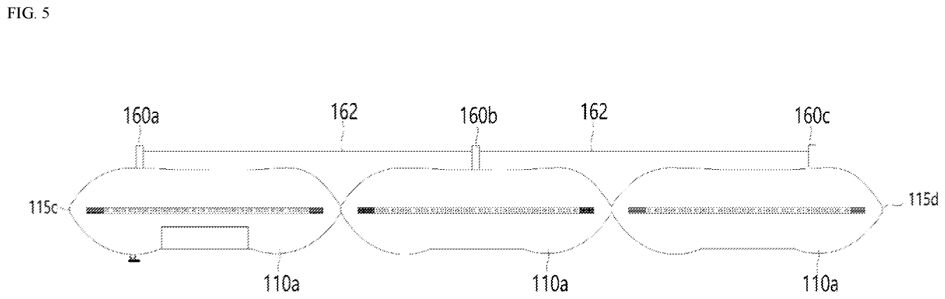

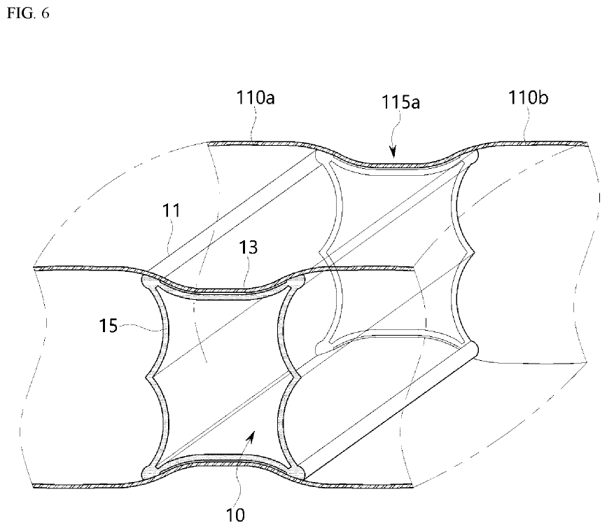

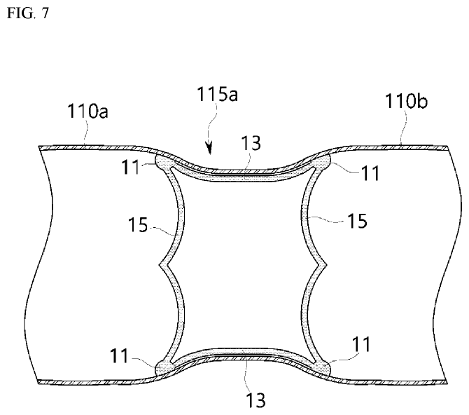

Here, FIG. 1 is a perspective view illustrating a folding type inflatable traffic accident notification device according to an embodiment of the present invention, when the traffic accident notification device is folded and fixed into a tripod shape of a traffic accident notification sign while inflated through gas injection and FIG. 2 is a front view of FIG. 1. In addition, FIG. 3 is a cross-sectional view illustrating a state when the traffic accident notification device is viewed from the front after being fully unfolded by releasing folding in FIG. 1, FIG. 4 is an enlarged view of a part A of FIG. 3, and a diagram specifically illustrating a functional module inserted into a tube, FIG. 5 is a view illustrating another embodiment of the present invention to which a structure for maintaining a shape between tube parts in an inflated state is applied based on FIG. 3, and FIGS. 6 and 7 are views illustrating an embodiment of a method of implementing a bendable part in the folding type inflatable traffic accident notification device according to the embodiment of the present invention.

According to FIGS. 1 to 7, a gas injection part 120 for gas injection is installed in the foldable tube member. Here, the gas injection part 120 may vary from a case simply consisting of an injection hole and a stopper to a case fabricated in the form of a valve having a predetermined structure. In addition, in the drawings, although it is illustrated that only one gas injection part 120 is installed at a predetermined position on the lower surface of the first tube part 110a, it is obvious that various modifications are possible in the installation position and number, and it is obvious that the gas injection part may serve as an inlet and an outlet together and may be provided separately.

The foldable tube member is externally divided into a first tube part 110a and a second tube part 110b each having the same length and a straight shape by the first bendable part 115a, and is externally divided into a second tube part 110b and a third tube part 110c each having the same length and a straight shape by the second bendable part 115b.

At this time, a through hole communicating between the first tube part 110a and the second tube part 110b is formed inside the tube at a position corresponding to the first bendable part 115a, and a through hole communicating between the second tube part 110b and the third tube part 110c may be formed inside the tube at a position corresponding to the second bendable part 115b. Accordingly, the gas injected through the gas injection part 120 may be injected from the first tube part 110a to the third tube part 110c. In the present example, the case in which the through hole is formed as a configuration for gas flow between tube parts is illustrated, but it is obvious that various technical methods that function as a gas flow passage enabling gas flow may be applied.

However, if the gas injection part is separately installed for each tube part, the through hole as described above may not necessarily be provided. Of course, according to the drawing, it is illustrated that a signal line and a power line, which connect the light emitting devices 150a, 150b, and 150c separately arranged for each tube part, are connected to the inner space of the tube through the through hole. Even if the gas injection part is installed for each tube part, the through hole may be required. However, since the light emitting devices 150a, 150b, and 150c may be installed on the outer surface of the tube member, the signal line and the power line do not necessarily have to be connected to the inside of the tube, and in this case, the provision of through holes may be omitted. However, hereinafter, for convenience and concentration of description, it will be described on the assumption of a case where the light emitting devices 150a, 150b, and 150c are installed on the inner surface or inner space of the tube member, and the signal line and the power line connecting the light emitting devices are connected through an inner through hole provided at a position corresponding to each bendable part.

In the present specification, the bendable part is a term encompassing all forms that perform a role of making a predetermined sign shape by folding the tube in an inflated state.

As an example, according to FIGS. 1 to 5 of the present specification, the bendable part is formed with a bending line by fusion bonding, sewing, etc. in one integrated tube member, and it is illustrated that the folded portion between the tube parts is made to be thinner.

As another example, in the embodiment of the present invention, the bendable part may be formed to have a predetermined width separately from each tube part, and as illustrated in FIGS. 6 and 7, a predetermined bendable guide 10 may be implemented to be installed in the inner space between the tube members. Here, FIGS. 6 and 7 are views of enlarging only a portion including the bending portion between the tube members. Referring to FIGS. 6 and 7, the bendable guide 10 may be implemented by including a plurality of fusion line members 11 which is fused and formed inside the upper surface of the tube (particularly, in the drawings, both points corresponding to the bending portion are illustrated) and inside the lower surface of the tube (similarly, in the drawings, both points corresponding to the bending portion are illustrated) corresponding to the bending portion to fix the bendable guide to the inner space of the tube; a horizontal connection member 13 surface-connecting the fusion line members in a horizontal direction, respectively, and formed of a flexible material (including a case of the same material as the tube material); and a vertical connection member 15 surface-connecting the fusion line member inside the upper surface of the tube and the fusion line member inside the lower surface of the tube in a vertical direction, respectively, and formed of a flexible material (including a case of the same material as the tube material).

Of course, it is obvious that various types of bendable parts can be implemented in addition to the bendable part shape illustrated in FIGS. 1 to 7.

According to the drawings, when the foldable tube member is folded through the first bendable part 115a and the second bendable part 115b in the inflated state according to the gas injection, connection parts 115c and 115d used to connect the first tube part 110a and the third tube part 110c are provided at both ends thereof.

At this time, with respect to the specific structure and shape of the connection parts 115c and 115d, although not clearly illustrated through the drawings, various types of fastening means such as a snap button type, a Velcro type, a hook type, a magnet type, and a sliding type fitting type may be applied. In addition, since separate members or means for coupling the connection parts to each other may be provided in a state where the connection parts at both ends are simply butted, the connection part itself may not be provided with a fastening means. In addition, in the drawings, although the connection parts are provided at both ends of the tube member, respectively, the connection part may be provided only on one side. This is because, for example, the connection part provided on only one side may be pulled to the other side to be combined with a fastening means provided on the surface of the tube part.

In addition, the tube type foldable tripod according to the embodiment of the present invention includes a light emitting apparatus installed on the foldable tube member. Here, the light emitting apparatus includes light emitting devices 150a, 150b, and 150c and a function module 130. In addition, here, the function module 130 may include a circuit board 144 on which a driving circuit for controlling a light emission operation is mounted therein; and a power supply unit 146 such as a disposable battery or a rechargeable battery, a driving button, and the like. As illustrated in the drawings, the case where the functional module 130 is disposed on the lower surface of the tube member is exemplified, but various modifications are possible, such as being disposed on the upper surface of the tube member.

The light emitting device includes a plurality of light emitting elements 150a, 150b, 150c; and an electric wire part made of a flexible material so that driving signals generated from the driving circuit are transmitted to the plurality of light emitting devices by connecting the plurality of light emitting devices on a single electric signal line.

At this time, the plurality of light emitting elements 150a, 150b, and 150c are provided in the first tube part 110a, the second tube part 110b, and the third tube part 110c in a longitudinal direction on both opposite sides outside the surface thereof, respectively. When the shape of the traffic accident notification sign is made through folding while the foldable tube member is inflated, a light emitting line corresponding to the external shape of the sign may be formed. However, according to the installation method, the plurality of light emitting elements 150a, 150b, and 150c may be installed in the inner space or inner surface of each tube part or a specific tube part.

In addition, the functional module 130 may be installed on the outer surface of the tube member, but the functional module 130 is provided to be inserted into the inner lower space of the tube member (the first tube part 110a with reference to the drawing) when described based on the example shown in the drawing. This is because the functional module 130 is provided to be inserted into the tube to help in the stable installation and the formation of a smooth appearance of the functional module.

To this end, according to the embodiment of FIG. 4, the embodiment may include a fixing plate 134 which is provided to be inserted into a predetermined lower portion of the tube part (for example, after an opening is provided to be inserted into the tube, a method of fusion-fixing the tube portion and the sidewall portion of the opening surface thereof may be used), has a through hole for passing through an electric wire connected to the light emitting elements, and has a space where the function module is installed; and a cover plate 132 coupled with the fixing plate to seal the insertion space by the fixing plate. At this time, a magnetic body 136 is provided at a position such as a predetermined portion of the cover plate 132, a lower portion thereof (see FIG. 4), and a surface opposite thereto (i.e., a surface opposite to the surface on which the function module 130 is installed in the tube part), and as a result, the device folded in the tripod shape may be fixed to a vehicle or the like. Of course, it is obvious that there may be various methods other than the method of using the magnetic body as the method of fixing the tripod, and it is obvious that the installation position of the fixing member such as a magnetic body may be more diverse than the positions illustrated in the drawings.

In the present specification, the case where the light emitting apparatus is installed on the tube type foldable tripod is mainly described based on the embodiment illustrated in the drawings, but a predetermined light reflector may be used to replace or use together the light emitting apparatus according to a product design method.

In addition, according to the embodiment of the present invention, a structure for maintaining the shape between the tube parts in the inflated state may be applied. This will be described as follows. Since bendable part in the tube type foldable tripod according to the embodiment of the present invention receives less force because less gas is injected than other parts (that is, each tube part) when gas is injected, there is a problem in that the tube parts on both sides that receive more force are twisted or bent based on the bendable part thereof, so the original straight shape is not maintained. As a result, finally, it may be difficult to fold the tube type foldable tripod into a desired sign shape. Accordingly, as illustrated in FIG. 5, another embodiment of the present invention may further include a shape-maintaining structure (see 160a, 160b, 160c, and 162) which is provided at one position of the outer surface of each of the first tube part 110a, the second tube part 110b, and the third tube part 110c to maintain the original shape when each tube part is inflated according to gas injection.

According to FIG. 5, the shape-maintaining structure is illustrated to be installed at a predetermined position on the upper side of each tube part, respectively, but the shape-maintaining structures may be installed only on the tube parts at both ends (i.e., the first tube part and the third tube part) in the inflated state in the straight shape. In addition, according to the drawings, it is illustrated that the shape-maintaining structure is installed only on the upper side of the tube part, but in order to maintain a more accurate shape, of course, a shape-maintaining structure having the same structure may be installed on the lower side of the tube part opposite to the upper side thereof. In addition, according to the drawings, it is illustrated that the shape-maintaining structure is configured by predetermined hook portions 160a, 160b, 160c and a connection body 162 connected to these hook portions, but of course, modifications into various structures capable of playing a role of maintaining the shape are possible. In addition, at this time, the connection body 162 may be used with various members (for example, elastic bands such as rubber bands) having elasticity to maintain the straight-shaped tension in a tight state, and as the hook portion, of course, various modifications such as a holder/fixture are possible.

According to the tube type foldable tripod as described above, when not in use, the volume is minimized by folding in a state where all of the gas is discharged to be carried and stored, and when in use, the tripod may be easily made by folding after gas injection and thus there is an excellent effect in terms of usability.

Hereinabove, the present invention has been described with reference to the embodiments, but it will be able to be easily appreciated by those skilled in the art that various modifications and changes of the present disclosure can be made without departing from the spirit and the scope of the present disclosure which are defined in the appended claims and their equivalents.

What is claimed is:

1. A folding type inflatable traffic accident notification device comprising:
a foldable tube member which is made of a material that is inflatable according to gas injection, has a bendable part to be foldably fabricated when being inflated according to gas injection, and includes a connection part used to fix the corresponding shape when the shape of a traffic accident notification sign is made through folding in the inflated state; and
a light member provided in the foldable tube member, wherein the light member includes at least one of a light emitting apparatus and a light reflector.

2. The folding type inflatable traffic accident notification device of claim 1, wherein the foldable tube member includes a gas injection part,
the foldable tube member is externally divided into a first tube part and a second tube part each having the same length and a straight shape by the first bendable part, and is externally divided into a second tube part and a third tube part each having the same length and a straight shape by the second bendable part,
a through hole communicating between the first tube part and the second tube part is formed inside the tube at a position corresponding to the first bendable part, and a through hole communicating between the second tube part and the third tube part is formed inside the tube at a position corresponding to the second bendable part, and
when the folding is made by the first bendable part and the second bendable part in the inflated state according to the gas injection, the connection part used to connect the first tube part and the third tube part is provided in at least one of the first tube part and the third tube part.

3. The folding type inflatable traffic accident notification device of claim 2, wherein the light emitting apparatus includes light emitting devices; and a functional module,
the function module includes: a circuit board on which a driving circuit for controlling a light emitting operation of the light emitting device is mounted; and a power supply part, and
the function module is provided to be inserted into any one of the first tube part, the second tube part, and the third tube part.

4. The folding type inflatable traffic accident notification device of claim 3, wherein the light emitting device is installed in at least one of an inner space, an inner surface, and an outer surface of at least one of the first tube part, the second tube part, and the third tube part, wherein when the shape of the traffic accident notification sign is made through folding while the foldable tube member is inflated, a light emitting line corresponding to the appearance of the sign is formed.

5. The folding type inflatable traffic accident notification device of claim 4, comprising:
a fixing plate which is provided to be inserted into a predetermined lower portion of any one of the first tube part, the second tube part, and the third tube part toward the inner side of the tube and provided with a space where the function module is installed;
a cover plate coupled with the fixing plate to seal the insertion space by the fixing plate; and
a magnetic body which is provided on at least one of a predetermined portion of the cover plate, a lower portion of the cover plate, and one surface of the tube part facing the cover plate.

6. The folding type inflatable traffic accident notification device of claim 2, further comprising:
shape-maintaining structures which are provided on outer surfaces of at least the first tube part and the third tube part among the first tube part, the second tube part, and the third tube part to maintain the original shape when each tube part is inflated according to gas injection.

7. The folding type inflatable traffic accident notification device of claim 1, wherein the bendable part has a bendable guide provided in an inner space corresponding to the bending portion of the tube part,
wherein the bendable guide includes:
a plurality of fusion line members which is fused and formed inside the upper surface of the tube and inside the lower surface of the tube corresponding to the bending portion to fix the bendable guide to the inner space of the tube;
a horizontal connection member surface-connecting the fusion line members in a horizontal direction, respectively, and formed of a flexible material; and
a vertical connection member surface-connecting the fusion line member inside the upper surface of the tube and the fusion line member inside the lower surface of the tube in a vertical direction, respectively, and formed of a flexible material.
